(19) United States
(12) Patent Application Publication
(10) Pub. No.: US 2022/0230543 A1
(43) Pub. Date: Jul. 21, 2022

(54) VEHICLE CONTROL APPARATUS, PARKING SUPPORT SYSTEM, AND PARKING SUPPORT METHOD

(71) Applicant: TOYOTA JIDOSHA KABUSHIKI KAISHA, Toyota-shi Aichi-ken (JP)

(72) Inventor: Takanori Imazu, Susono-shi (JP)

(73) Assignee: TOYOTA JIDOSHA KABUSHIKI KAISHA, Toyota-shi Aichi-ken (JP)

(21) Appl. No.: 17/549,209

(22) Filed: Dec. 13, 2021

(30) Foreign Application Priority Data
Jan. 19, 2021 (JP) 2021-006547

(51) Int. Cl. G08G 1/14; G06Q 50/30; B60W 30/06

(52) U.S. Cl. CPC G08G 1/145; G06Q 50/30; B62D 15/0285; G05D 2201/0213; B60W 30/06

(57) ABSTRACT

A vehicle control apparatus loads a vehicle into a parking space of a parking lot or unloads the vehicle from the parking space, by causing the vehicle to run in a self-propelled manner. The vehicle control apparatus is equipped with a reception unit that receives, from a control center at the parking lot, map information including mark information on a plurality of marks for identifying a position of the vehicle at the parking lot, a computation unit that computes each of intervals between the marks, based on the mark information included in the map information, and a determination unit that determines whether or not each of the computed intervals is a predetermined interval.

### CROSS-REFERENCE TO RELATED APPLICATION

This application claims priority to Japanese Patent Application No. 2021-006547 filed on Jan. 19, 2021, incorporated herein by reference in its entirety.

### BACKGROUND

### 1. Technical Field

The disclosure relates to a technical field of a vehicle control apparatus, a parking support system, and a parking support method for loading and unloading a vehicle by causing the vehicle to run in a self-propelled manner.

### 2. Description of Related Art

As an art regarding this kind of apparatus, for example, there is proposed a navigation apparatus that receives operation support information including a floor map reflecting information on occupations or vacancies on a parking lot map, and a block map reflecting warning information and the like on the parking lot map, from an operation support device that supports the operation of a vehicle within a parking lot (see Japanese Unexamined Patent Application Publication No. 2016-197314 (JP 2016-197314 A)). Incidentally, it is described in JP 2016-197314 A that this navigation apparatus is also applicable to an automatically operable vehicle.

### SUMMARY

In the case where information is transmitted and received between a vehicle and a device outside the vehicle, an error may occur in the transmitted and received information (e.g., the garbling of the information due to the lack or transformation of part thereof). When there is an error in the transmitted and received information, the control of the vehicle may be affected. The art described in JP 2016-197314 A does not take into account the possibility of an error occurring in the transmitted and received information.

The disclosure has been made in view of the foregoing problem. It is a task of the disclosure to provide a vehicle control apparatus, a parking support system, and a parking support method that can detect an error in information resulting transmission and reception.

A vehicle control apparatus according to one aspect of the disclosure is a vehicle control apparatus configured to be able to communicate with a control center of a parking lot so as to load a vehicle into a parking space of the parking lot or unload the vehicle from the parking space by causing the vehicle to run in a self-propelled manner. The vehicle control apparatus is equipped with a reception unit that receives, from the control center, map information including mark information on a plurality of marks for identifying a position of the vehicle at the parking lot, a computation unit that computes each of intervals between the marks, based on the mark information included in the map information, and a determination unit that determines whether or not each of the computed intervals is a predetermined interval.

A parking support system according to another aspect of the disclosure is a parking support system that loads a vehicle into a parking space of a parking lot or unload the vehicle from the parking space, by causing the vehicle to run in a self-propelled manner. The parking support system is equipped with a control center that provides the vehicle at the parking lot with instructions and information, and a vehicle control apparatus that is mounted in the vehicle and that is configured to be able to communicate with the control center. The vehicle control apparatus includes a reception unit that receives, from the control center, map information including mark information on a plurality of marks for identifying a position of the vehicle at the parking lot, a computation unit that computes each of intervals between the marks, based on the mark information included in the map information, and a determination unit that determines whether or not each of the computed intervals is a predetermined interval.

A parking support method according to still another aspect of the disclosure is a parking support method for loading a vehicle into a parking space of a parking lot or unloading the vehicle from the parking space, by causing the vehicle to run in a self-propelled manner. The parking support method includes a reception process in which the vehicle receives, from a control center at the parking lot, map information including mark information on a plurality of marks for identifying a position of the vehicle at the parking lot, a computation process in which the vehicle computes each of intervals between the marks, based on the mark information included in the map information, and a determination process in which the vehicle determines whether or not each of the computed intervals is a predetermined interval.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a parking support system according to one of the embodiments;

FIG. 2 is a view showing part of a parking lot; and

FIG. 3 is a block diagram showing the behavior of the parking support system according to the embodiment.

### DETAILED DESCRIPTION OF EMBODIMENTS

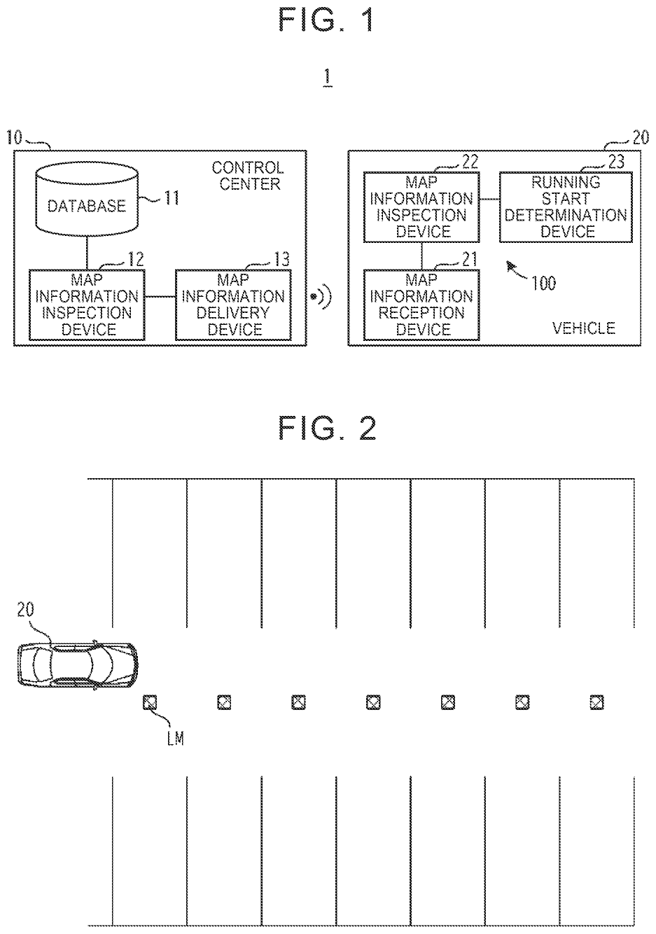

One of the embodiments of a parking support system will be described with reference to FIGS. 1 to 3. A parking support system 1 according to the embodiment loads an unmanned (i.e., with no passengers) vehicle 20 into a parking space or unloads the vehicle 20 from the parking space, by causing the vehicle 20 to run in a self-propelled manner.

It should be noted herein that the expression “to run in a self-propelled manner” means that the vehicle moves without being manipulated by a driver. As a concrete example of the expression “to run in a self-propelled manner”, it is possible to mention a mode in which the vehicle moves (runs) due to an automatic operation function assigned to the vehicle, or a mode in which the vehicle moves through the use of a robot that tows the vehicle. Incidentally, although the mode in which the vehicle 20 moves due to the automatic operation function assigned to the vehicle 20 will be described in the following description, the disclosure is not limited thereto.

In FIG. 1, the parking support system 1 is configured to be equipped with a control center 10 and a vehicle control apparatus 100 mounted in the vehicle 20. The control center 10 and the vehicle control apparatus 100 are configured to be able to communicate with each other. Incidentally, the control center 10 may be installed on the premises of the parking lot into which the vehicle 20 is loaded or from which the vehicle 20 is unloaded, or may be installed in a place different from the premises. Besides, the control center 10 may be structured physically, or may be virtually structured on a network.

The control center 10 provides the vehicle 20 at the parking lot with instructions and pieces of information. It should be noted herein that as the instructions with which the vehicle 20 is provided by the control center 10, it is possible to mention, for example, “the start of loading”, “the start of unloading”, “temporary stop”, “suspension”, and the like. As the pieces of information with which the vehicle 20 is provided by the control center 10, it is possible to mention, for example, “map information on the parking lot”, “route information”, “the hour for starting loading”, “the hour for starting unloading”, and the like.

The control center 10 is configured to be equipped with a database 11 including map information regarding a relevant parking lot, a map information inspection device 12, and a map information delivery device 13. It should be noted herein that a plurality of landmarks LM are disposed at a predetermined interval on a passageway on which the vehicle 20 can move, as shown in, for example, FIG. 2, at the parking lot to be controlled by the control center 10. The map information includes landmark information indicating positional coordinates, identification numbers, and the like of the respective landmarks LM.

When the vehicle 20 moves within the parking lot, the vehicle control apparatus 100 detects the landmarks LM through the use of, for example, an in-vehicle camera (not shown) or the like, and estimates a position of the vehicle 20 within the parking lot by comparing the detected landmarks LM with the landmark information included in the map information.

By the way, when the map information is delivered (transmitted) from the control center 10 to the vehicle control apparatus 100 of the vehicle 20, an error may occur in the map information as a result of, for example, the lack or transformation of part of the information. In particular, when an error occurs in the landmark information included in the map information, the vehicle control apparatus 100 may become unable to correctly estimate the position of the vehicle 20 within the parking lot.

In contrast, in the parking support system 1, it is determined whether or not an error has occurred in the map information as a result of communication between the control center 10 and the vehicle control apparatus 100. In concrete terms, as described above, the landmarks LM are disposed at the predetermined interval. Thus, the vehicle control apparatus 100 inspects each of intervals between the landmarks LM indicated by the landmark information, included in the map information received from the control center 10. The vehicle control apparatus 100 then determines that there is no error in the map information, when each of the intervals between the landmarks LM indicated by the landmark information is the predetermined interval. On the other hand, the vehicle control apparatus 100 determines that an error has occurred in the map information, when each of the intervals between the landmarks LM indicated by the landmark information is not the predetermined interval.

It should be noted herein that the vehicle control apparatus 100 is configured to be equipped with a map information reception device 21 that receives the map information from the control center 10, a map information inspection device 22 that conducts the foregoing inspection, and a running start determination device 23.

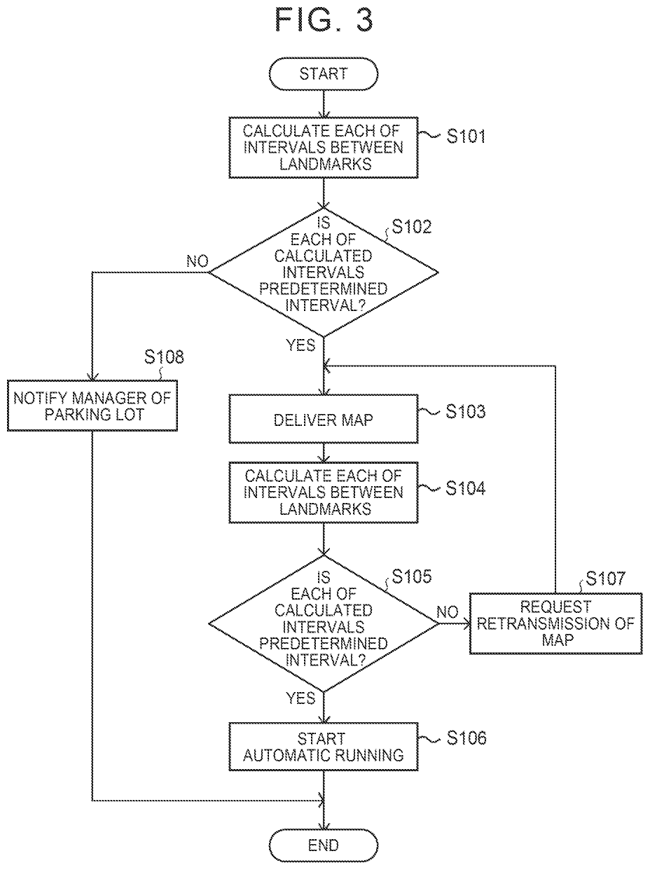

Next, the behavior of the parking support system 1 will be additionally described with reference to a flowchart of FIG. 3.

In the case where the vehicle 20 mounted with the vehicle control apparatus 100 is loaded into a parking space, when a user of the vehicle 20 gets off the vehicle at a predetermined place (e.g., a platform or the like) and assumes a behavior of indicating, for example, a permission for parking, the vehicle control apparatus 100 communicates with the control center 10. The control center 10 decides the parking space into which the vehicle 20 is to be loaded, a route along which the vehicle 20 is to be loaded, and the like, based on, for example, the situations of respective parking spaces of the parking lot or the like. After that, the control center 10 delivers map information to the vehicle control apparatus 100 of the vehicle 20.

When the vehicle 20 mounted with the vehicle control apparatus 100 is unloaded from the parking space, the control center 10 decides a place (e.g., a platform or the like) to which the vehicle 20 is to be moved, a route along which the vehicle 20 is to be unloaded, and the like, a predetermined time prior to a scheduled timing for unloading the vehicle 20 or upon the issuance of a command to unload the vehicle 20. After that, the control center 10 delivers the map information to the vehicle control apparatus 100 of the vehicle 20.

The behavior indicated by the flowchart of FIG. 3 corresponds to the behavior after the decision of the route along which the vehicle 20 is to be loaded or unloaded, and the like. In FIG. 3, steps S101 to S103 and S108 represent the behavior of the control center 10, and steps S104 to S107 represent the behavior of the vehicle control apparatus 100.

In FIG. 3, the map information inspection device 12 of the control center 10 acquires the map information to be delivered to the vehicle 20, from the database 11. The map information inspection device 12 then calculates each of intervals between the landmarks LM indicated by landmark information included in the acquired map information, as inspection of the map information (step S101).

Subsequently, the map information inspection device 12 determines whether or not each of the calculated intervals is a predetermined interval (step S102). If it is determined in the processing of step S102 that each of the calculated intervals is not the predetermined interval (No in step S102), the control center 10 notifies, for example, a terminal used by the manager of the parking lot that there is an abnormality in the map information included in the database 11 (step S108). At this time, the control center 10 may transmit a signal indicating the suspension of loading or unloading or the disapproval of automatic operation to the vehicle control apparatus 100 of the vehicle 20.

If it is determined in the processing of step S102 that each of the calculated intervals is the predetermined interval (Yes in step S102), the map information delivery device 13 delivers the map information inspected by the map information inspection device 12 to the vehicle control apparatus 100 of the vehicle 20 (step S103).

After the map information reception device 21 of the vehicle control apparatus 100 receives the map information, the map information inspection device 22 calculates each of intervals between the landmarks LM indicated by the landmark information included in the received map information, as inspection of the map information (step S104). Subsequently, the map information inspection device 22 determines whether or not each of the calculated intervals is the predetermined interval (step S105).

If it is determined in the processing of step S105 that each of the calculated intervals is not the predetermined interval (No in step S105), the map information inspection device 22 requests the control center 10 to retransmit map information (step S107). If it is determined in the processing of step S105 that each of the calculated intervals is the predetermined interval (Yes in step S105), the running start determination device 23 determines that the running of the vehicle 20 should be started to load or unload the vehicle 20 (step S106).

### Technical Effect

In the parking support system 1, the map information determined as normal (the map information as to which it is determined that each of the intervals between the landmarks LM is the predetermined interval, in the foregoing embodiment) is transmitted to the vehicle control apparatus 100, in the control center 10. The vehicle control apparatus 100 then determines whether or not the map information received from the control center 10 is normal (it is determined in the foregoing embodiment whether or not each of the intervals between the landmarks LM is the predetermined interval). Therefore, when it is determined in the vehicle control apparatus 100 that the map information is not normal, it is safe to conclude that the cause of this determination lies in the transmission and reception of information between the control center 10 and the vehicle control apparatus 100. Accordingly, the parking support system 1 can detect an error in information resulting from transmission and reception.

Incidentally, “the predetermined interval” may be determined in, for example, designing the parking lot relevant to the parking support system 1. In the care where a common standard is determined as to the parking lot into or from which the vehicle caused to run in a self-propelled manner is loaded or unloaded, “the predetermined interval” may be determined according to this standard. The map information inspection device 22 of the vehicle control apparatus 100 may have information on “the predetermined interval” in advance, or may acquire such information from the control center 10 or, for example, a server on a network or the like, in conducting an inspection of the map information.

### MODIFICATION EXAMPLES

The map information may include, for example, information indicating positional coordinates, identity attributes and the like of a plurality of frame borders prescribing parking spaces, and information indicating positional coordinates, identity attributes and the like of a plurality of barrier curbs (e.g., parking blocks or the like), in addition to or instead of the landmark information. In this case, the map information inspection devices 12 and 22 may inspect the map information through the use of, the frame borders or the barrier curbs, instead of or in addition to the landmarks LM indicated by the landmark information. That is, the map information may be inspected through the use of objects that are regularly provided at an interval determined in advance at the parking lot and that can be detected by an in-vehicle sensor such as a camera.

The landmarks LM may be disposed at an equal interval. In this case, the map information inspection devices 12 and 22 may determine that the map information is normal, on the condition that the calculated intervals between the landmarks LM be equal to one another (in other words, without determining whether or not each of the calculated intervals is the predetermined interval).

The vehicle control apparatus 100 may not be equipped with the map information inspection device 22. In this case, upon receiving map information from the control center 10, the vehicle control apparatus 100 may inspect the map information by downloading a program for inspecting the map information from, for example, the control center 10, a server on a network, or the like and executing the program. The downloaded program may be deleted from the vehicle control apparatus 100 when the inspection of the map information is ended (e.g., if it is determined in the foregoing processing of step S105 that each of the calculated intervals is the predetermined interval).

In the foregoing embodiment, the vehicle 20 moves due to the automatic operation function assigned to the vehicle 20. However, the vehicle 20 may be moved by being towed by a robot. In this case, the vehicle control apparatus 100 may be mounted on the robot for towing the vehicle 20.

Various aspects of the disclosure derived from the embodiment and modification examples described above will be described below.

A vehicle control apparatus according to one aspect of the disclosure is a vehicle control apparatus configured to be able to communicate with a control center of a parking lot so as to load a vehicle into a parking space of the parking lot or unload the vehicle from the parking space by causing the vehicle to run in a self-propelled manner. The vehicle control apparatus includes a reception unit that receives, from the control center, map information including mark information on a plurality of marks for identifying a position of the vehicle at the parking lot, a computation unit that computes each of intervals between the marks, based on the mark information included in the map information, and a determination unit that determines whether or not each of the computed intervals is a predetermined interval.

In the foregoing embodiment, “the map information reception device 21” corresponds to an example of “the reception unit”, “the map information inspection device 22” corresponds to an example of “the computation unit” and “the determination unit”, and “the landmark information” corresponds to an example of “the mark information”.

The vehicle control apparatus may be equipped with a transmission unit that transmits a request for retransmission of the map information to the control center, when the determination unit determines that each of the computed intervals is not the predetermined interval. In the foregoing embodiment, “the map information detection device 22” corresponds to an example of “the transmission unit”.

The marks may be a plurality of landmarks installed at the parking lot, or a plurality of frame borders prescribing the parking space.

A parking support system according to another aspect of the disclosure is a parking support system that loads a vehicle into a parking space of a parking lot or unload the vehicle from the parking space, by causing the vehicle to run in a self-propelled manner. The parking support system is equipped with a control center that provides the vehicle at the parking lot with instructions and information, and a vehicle control apparatus that is mounted in the vehicle and that is configured to be able to communicate with the control center. The vehicle control apparatus includes a reception unit that receives, from the control center, map information including mark information on a plurality of marks for identifying a position of the vehicle at the parking lot, a computation unit that computes each of intervals between the marks, based on the mark information included in the map information, and a determination unit that determines whether or not each of the computed intervals is a predetermined interval.

The vehicle control apparatus may have a transmission unit that transmits a request for retransmission of the map information to the control center, when the determination unit determines that each of the computed intervals is not the predetermined interval.

The control center may compute each of the intervals between the marks, based on the mark information included in the map information, before transmitting the map information to the vehicle control apparatus.

A parking support method according to still another aspect of the disclosure is a parking support method for loading a vehicle into a parking space of a parking lot or unloading the vehicle from the parking space, by causing the vehicle to run in a self-propelled manner. The parking support method includes a reception process in which the vehicle receives, from a control center at the parking lot, map information including mark information on a plurality of marks for identifying a position of the vehicle at the parking lot, a computation process in which the vehicle computes each of intervals between the marks, based on the mark information included in the map information, and a determination process in which the vehicle determines whether or not each of the computed intervals is a predetermined interval.

The parking support method may include a transmission process in which the vehicle transmits a request for retransmission of the map information to the control center, when it is determined in the determination process that each of the computed intervals is not the predetermined interval.

The parking support method may include a second computation process in which the control center computes each of the intervals between the marks, based on the mark information included in the map information, before the reception process.

The disclosure is not limited to the foregoing embodiment, but can be appropriately altered within such a range as not to contradict the gist or idea of the disclosure that can be read out from the claims and the entire specification. A vehicle control apparatus, a parking support system, and a parking support method that are subjected to such alterations also fall within the technical scope of the disclosure.

What is claimed is:

1. A vehicle control apparatus configured to be able to communicate with a control center of a parking lot so as to load a vehicle into a parking space of the parking lot or unload the vehicle from the parking space by causing the vehicle to run in a self-propelled manner, the vehicle control apparatus comprising:
a reception unit that receives, from the control center, map information including mark information on a plurality of marks for identifying a position of the vehicle at the parking lot;
a computation unit that computes each of intervals between the marks, based on the mark information included in the map information; and
a determination unit that determines whether or not each of the computed intervals is a predetermined interval.

2. The vehicle control apparatus according to claim 1, further comprising:
a transmission unit that transmits a request for retransmission of the map information to the control center, when the determination unit determines that each of the computed intervals is not the predetermined interval.

3. The vehicle control apparatus according to claim 1, wherein
the marks are a plurality of landmarks installed at the parking lot, or a plurality of frame borders prescribing the parking space.

4. A parking support system that loads a vehicle into a parking space of a parking lot or unload the vehicle from the parking space, by causing the vehicle to run in a self-propelled manner, the parking support system comprising:
a control center that provides the vehicle at the parking lot with instructions and information; and
a vehicle control apparatus that is mounted in the vehicle and that is configured to be able to communicate with the control center, wherein
the vehicle control apparatus includes a reception unit that receives, from the control center, map information including mark information on a plurality of marks for identifying a position of the vehicle at the parking lot, a computation unit that computes each of intervals between the marks, based on the mark information included in the map information, and a determination unit that determines whether or not each of the computed intervals is a predetermined interval.

5. The parking support system according to claim 4, wherein
the vehicle control apparatus has a transmission unit that transmits a request for retransmission of the map information to the control center, when the determination unit determines that each of the computed intervals is not the predetermined interval.

6. The parking support system according to claim 4, wherein
the control center computes each of the intervals between the marks, based on the mark information included in the map information, before transmitting the map information to the vehicle control apparatus.

7. A parking support method for loading a vehicle into a parking space of a parking lot or unloading the vehicle from the parking space, by causing the vehicle to run in a self-propelled manner, the parking support method comprising:
a reception process in which the vehicle receives, from a control center at the parking lot, map information including mark information on a plurality of marks for identifying a position of the vehicle at the parking lot;
a computation process in which the vehicle computes each of intervals between the marks, based on the mark information included in the map information; and
a determination process in which the vehicle determines whether or not each of the computed intervals is a predetermined interval.

8. The parking support method according to claim 7, further comprising:
a transmission process in which the vehicle transmits a request for retransmission of the map information to the control center, when it is determined in the determination process that each of the computed intervals is not the predetermined interval.

9. The parking support method according to claim 7, further comprising:
a second computation process in which the control center computes each of the intervals between the marks, based on the mark information included in the map information, before the reception process.
